(19) United States
(12) Patent Application Publication
(10) Pub. No.: US 2025/0236814 A1
(43) Pub. Date: Jul. 24, 2025

(54) AUTOMATIC DISHWASHING COMPOSITION

(71) Applicants: Dow Silicones Corporation, Midland, MI (US); Rohm and Haas Company, Collegeville, PA (US)

(72) Inventors: Clara Leclaire, Uccle (BE); Saugata Nad, Brussels (BE); Serge Creutz, Liege (BE); Severine Cauvin, Mons (BE); Scott Backer, Phoenixville, PA (US)

(21) Appl. No.: 18/702,126

(22) PCT Filed: Nov. 3, 2022
(86) PCT No.: PCT/US2022/048760

§ 371 Date: Apr. 17, 2024

Related U.S. Application Data
(60) Provisional application No. 63/276,813, filed on Nov. 8, 2021.

(51) Int. Cl. C11D 3/37; C11D 1/72; C11D 3/04; C11D 3/10; C11D 3/386; C11D 3/39; C11D 3/395

(52) U.S. Cl. CPC C11D 3/3719; C11D 1/72; C11D 3/042; C11D 3/10; C11D 3/3757; C11D 3/378; C11D 3/386; C11D 3/3917; C11D 3/3951; C11D 2111/14

(57) ABSTRACT

An automatic dishwashing composition is provided including a builder; a nonionic surfactant; a poly(glutamic acid); and a dispersant polymer selected from the group consisting of: (a) a non-sulfonated hydrophobic modified polymer, comprising (i) 60 to 98 wt %, based on weight of the non-sulfonated hydrophobic modified polymer, of structural units of formula I

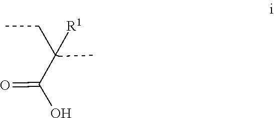

wherein each R¹ is independently selected from a hydrogen and a —CH₃ group; and (ii) 2 to 40 wt %, based on weight of the non-sulfonated hydrophobic modified polymer, of structural units of formula II

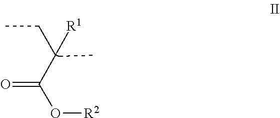

wherein each R² is independently selected from a —C₁₋₄ alkyl group and wherein each R³ is independently selected from a hydrogen and a methyl group; (b) a sulfonated polymer; (c) an acrylic acid homopolymer; and (d) a mixtures thereof.

The present invention relates to a dispersant polymer for use in automatic dish washing formulations. In particular, the present invention relates to automatic dishwashing compositions, comprising: a builder; a nonionic surfactant; a poly(glutamic acid); and a dispersant polymer selected from the group consisting of: (a) a non-sulfonated hydrophobic modified polymer, comprising (i) 60 to 98 wt %, based on weight of the non-sulfonated hydrophobic modified polymer, of structural units of formula I

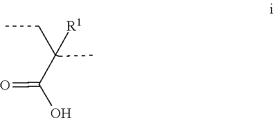

wherein each R¹ is independently selected from a hydrogen and a —CH₃ group; and (ii) 2 to 40 wt %, based on weight of the non-sulfonated hydrophobic modified polymer, of structural units of formula II

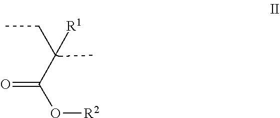

wherein each R² is independently selected from a —C₁₋₄ alkyl group and wherein each R³ is independently selected from a hydrogen and a methyl group; (b) a sulfonated polymer; (c) an acrylic acid homopolymer; and (d) a mixtures thereof.

Automatic dishwashing compositions are generally recognized as a class of detergent compositions distinct from those used for fabric washing or water treatment. Automatic dishwashing compositions are expected by users to produce a spotless and film-free appearance on washed articles after a complete cleaning cycle.

Phosphate-free automatic dishwashing compositions are increasingly desirable. Phosphate-free automatic dishwashing compositions typically rely on non-phosphate builders, such as salts of citrate, carbonate, silicate, disilicate, bicarbonate, aminocarboxylates and others to sequester calcium and magnesium from hard water, and upon drying, leave an insoluble visible deposit.

A family of polycarboxylate copolymers and their use as builders in detergent compositions and rinse aid compositions is disclosed by Christopher et al. in U.S. Pat. No. 5,431,846 for use in the final rinse step of a dish or warewashing machine. Christopher et al. disclose block copolymers comprising from 20 to 95 mole % of monomer units derived from itaconic acid or a homologue thereof and from 5 to 80 mole % of monomer units derived from vinyl alcohol or a lower vinyl ester are excellent binders of divalent or polyvalent metals and are useful as potentially biodegradable builders in detergent compositions as well as in machine dishwashing compositions and anti-scaling rinse compositions.

A family of terpolymers and their use, among other things, as dispersants is disclosed by Swift et al in U.S. Pat. No. 5,191,048. Swift et al teach a terpolymer comprising as polymerized units from about 15 to 55 mole percent of at least one first monomer selected from the group consisting of vinyl acetate, vinyl ethers and vinyl carbonates, from about 10 to 70 mole percent of at least one second monomer of an ethylenically unsaturated monocarboxylic acid, and from about 15 to 55 mole percent of at least one third monomer of an anhydride of a dicarboxylic acid and wherein said terpolymer is formed in a non-aqueous system such that less than about one more percent of the monomers are hydrolyzed during said polymerization.

Notwithstanding there remains a need for new dispersant polymers for use in automatic dish washing formulations. In particular, there remains a need for new dispersant polymers for use in automatic dish washing formulations, wherein the dispersant polymers provide effective spotting/filming shine performance; are biosourced and biodegradable.

The present invention provides an automatic dishwashing composition, comprising: a builder; a nonionic surfactant; a poly(glutamic acid); and a dispersant polymer selected from the group consisting of: (a) a non-sulfonated hydrophobic modified polymer, comprising (i) 60 to 98 wt %, based on weight of the non-sulfonated hydrophobic modified polymer, of structural units of formula I

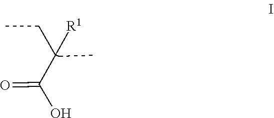

wherein each R¹ is independently selected from a hydrogen and a —CH₃ group; and
(ii) 2 to 40 wt %, based on weight of the non-sulfonated hydrophobic modified polymer, of structural units of formula II

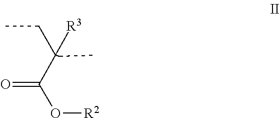

wherein each R² is independently selected from a —C₁₋₄ alkyl group and wherein each R³ is independently selected from a hydrogen and a methyl group; (b) a sulfonated polymer; (c) an acrylic acid homopolymer; and (d) a mixtures thereof.

The present invention provides a method of cleaning an article in an automatic dishwashing machine, comprising: providing at least one soiled article; providing an automatic dishwashing composition according to the present invention; and, applying the automatic dishwashing composition to the at least one soiled article to provide a cleaned article.

### DETAILED DESCRIPTION

When incorporated in an automatic dishwashing composition (particularly phosphate-free automatic dishwashing compositions), the combination of poly(glutamic acid) and a dispersant polymer selected from the group consisting of (a) a non-sulfonated hydrophobic modified polymer, (b) a sulfonated polymer, (c) an acrylic acid homopolymer and (d) a mixtures thereof; surprisingly provide antispotting/antifilming shine performance that is at least on par with conventional automatic dishwashing formulations, while significantly improving the overall sustainability of the automatic dishwashing composition.

Unless otherwise indicated, ratios, percentages, parts, and the like are by weight. Weight percentages (or wt %) in the composition are percentages of dry weight, i.e., excluding any water that may be present in the composition. Percentages of monomer units in the polymer are percentages of dry weight, i.e., excluding any water present in a polymer emulsion.

As used herein, unless otherwise indicated, the terms “weight average molecular weight” and “Mw” are used interchangeably to refer to the weight average molecular weight as measured in a conventional manner with gel permeation chromatography (GPC) and conventional standards, such as polystyrene standards. GPC techniques are discussed in detail in Modem Size Exclusion Chromatography, W. W. Yau, J. J. Kirkland, D. D. Bly; Wiley-lnterscience, 1979, and in A Guide to Materials Characterization and Chemical Analysis, J. P. Sibilia; VCH, 1988, p. 81-84. Weight average molecular weights are reported herein in units of Daltons.

The term “ethylenically unsaturated” as used herein and in the appended claims describes molecules having a carbon-carbon double bond, which renders it polymerizable. The term “multi-ethylenically unsaturated” as used herein and in the appended claims describes molecules having at least two carbon-carbon double bonds.

As used herein the term “(meth)acrylic” refers to either acrylic or methacrylic.

The term “phosphate-free” as used herein and in the appended claims means compositions containing ≤1 wt % (preferably, ≤0.5 wt %; more preferably, ≤0.2 wt %; still more preferably, ≤0.01 wt %; yet still more preferably, ≤0.001 wt %; most preferably, less than the detectable limit), based on dry weight of the automatic dishwashing composition, of phosphate.

The term “structural units” as used herein and in the appended claims refers to the remnant of the indicated monomer; thus a structural unit of (meth)acrylic acid is illustrated:

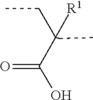

wherein the dotted lines represent the points of attachment to the polymer backbone and where R¹ is a hydrogen for structural units of acrylic acid and a —CH₃ for structural units of methacrylic acid.

Preferably, the automatic dishwashing composition of the present invention, comprises: a builder (preferably, 1 to 97 wt % (more preferably ≥1 wt %; still more preferably, ≥10 wt %; yet still more preferably, ≥25 wt %; most preferably, ≥50 wt %; preferably, ≤95 wt %; more preferably, ≤90 wt %; still more preferably, ≤85 wt %; most preferably, ≤80 wt %), based on dry weight of the automatic dishwashing composition, of the builder) (preferably, wherein the builder includes at least one of a carbonate, a bicarbonate, a citrate and a silicate); a nonionic surfactant (preferably, 0.2 to 15 wt % (more preferably, 0.5 to 10 wt %; most preferably, 1.5 to 8.5 wt %), based on dry weight of the automatic dishwashing composition, of the nonionic surfactant)(preferably, wherein the nonionic surfactant is a fatty alcohol alkoxylate); a poly(glutamic acid) (preferably, 0.2 to 15 wt % (more preferably, 0.5 to 10 wt %; most preferably, 1.0 to 5 wt %), based on dry weight of the automatic dishwashing composition, of the poly(glutamic acid))(preferably, wherein the poly(glutamic acid) has a weight average molecular weight of 1,000 to 200,000 Daltons (preferably, 2,000 to 150,000 Daltons; more preferably, 2,500 to 100,000 Daltons; still more preferably, 5,000 to 75,000 Daltons; most preferably; 7,500 to 60,000 Daltons); and a dispersant polymer (preferably, 0.5 to 15 wt % (more preferably, 0.5 to 10 wt %; still more preferably, 1 to 8 wt %; most preferably, 2 to 6.5 wt %), based on dry weight of the automatic dishwashing composition, of the dispersant) selected from the group consisting of: (a) a non-sulfonated hydrophobic modified polymer, comprising (i) 60 to 98 wt %, based on weight of the non-sulfonated hydrophobic modified polymer, of structural units of formula I

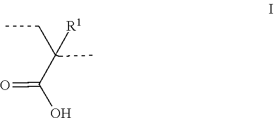

wherein each R¹ is independently selected from a hydrogen and a —CH₃ group; and (ii) 2 to 40 wt %, based on weight of the non-sulfonated hydrophobic modified polymer, of structural units of formula II

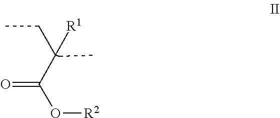

wherein each R² is independently selected from a —C₁₋₄ alkyl group and wherein each R³ is independently selected from a hydrogen and a methyl group; (b) a sulfonated polymer; (c) an acrylic acid homopolymer; and (d) a mixtures thereof (preferably, a non-sulfonated hydrophobic modified polymer of (a), sulfonated polymer of (b) or a combination of a non-sulfonated hydrophobic modified polymer of (a) and a sulfonated polymer of (b); more preferably, a non-sulfonated hydrophobic modified polymer of (a) or a combination of a non-sulfonated hydrophobic modified polymer of (a) and a sulfonated polymer of (b)).

Preferably, the automatic dishwashing composition of the present invention, comprises: a builder. Preferably, the builder used in the automatic dishwashing composition of the present invention, comprises at least one of a carbonate, a citrate and a silicate. Most preferably, the builder used in the automatic dishwashing composition of the present invention, comprises at least one of sodium carbonate, sodium bicarbonate and sodium citrate.

Preferably, the automatic dishwashing composition of the present invention, comprises: 1 to 97 wt %, based on dry weight of the automatic dishwashing composition, of a builder. Preferably, the automatic dishwashing composition of the present invention, comprises: ≥1 wt % (preferably, ≥10 wt %; more preferably, ≥25 wt %; most preferably, ≥50 wt %), based on dry weight of the automatic dishwashing composition, of the builder. Preferably, the automatic dishwashing composition of the present invention, comprises: ≤95 wt % (preferably, ≤90 wt %; more preferably, ≤85 wt %; most preferably, ≤80 wt %), based on dry weight of the automatic dishwashing composition, of the builder. Weight percentages of carbonates, citrates and silicates are based on the actual weights of the salts, including metal ions.

The term “carbonate(s)” as used herein and in the appended claims refers to alkali metal or ammonium salts of carbonate, bicarbonate, percarbonate, and/or sesquicarbonate. Preferably, the carbonate used in the automatic dishwashing composition (if any) is selected from the group consisting of carbonate salts of sodium, potassium and lithium (more preferably, salts of sodium or potassium; most preferably, salts of sodium). Percarbonate used in the automatic dishwashing composition (if any) is selected from salts of sodium, potassium, lithium and ammonium (more preferably, salts of sodium or potassium; most preferably, salts of sodium). Most preferably, the carbonate used in the automatic dishwashing composition (if any) includes at least one of sodium carbonate, sodium bicarbonate and sodium percarbonate. Preferably, when the builder used in the automatic dishwashing composition of the present invention includes carbonate, the automatic dishwashing composition preferably, comprises 0 to 97 wt % (preferably, 5 to 75 wt %; more preferably, 10 to 60 wt %; most preferably 20 to 50 wt %), based on dry weight of the automatic dishwashing composition, of carbonate.

The term “citrate(s)” as used herein and in the appended claims refers to alkali metal citrates. Preferably, the citrate used in the automatic dishwashing composition (if any) is selected from the group consisting of citrate salts of sodium, potassium and lithium (more preferably, salts of sodium or potassium; most preferably, salts of sodium). More preferably, the citrate used in the automatic dishwashing composition (if any) is sodium citrate. Preferably, when the builder used in the automatic dishwashing composition of the present invention includes citrate, the automatic dishwashing composition preferably, comprises 0 to 97 wt % (preferably, 5 to 75 wt %; more preferably, 10 to 60 wt %; most preferably 20 to 40 wt %), based on dry weight of the automatic dishwashing composition, of the citrate.

The term “silicate(s)” as used herein and in the appended claims refers to alkali metal silicates. Preferably, the silicate used in the automatic dishwashing composition (if any) is selected from the group consisting of silicate salts of sodium, potassium and lithium (more preferably, salts of sodium or potassium; most preferably, salts of sodium). More preferably, the silicate used in the automatic dishwashing composition (if any) is sodium disilicate. Preferably, the builder used in the automatic dishwashing composition of the present invention includes a silicate. Preferably, when the builder used in the automatic dishwashing composition of the present invention includes a silicate, the automatic dishwashing composition preferably, comprises 0 to 97 wt % (preferably, 0.1 to 10 wt %; more preferably, 0.5 to 7.5 wt %; most preferably 0.75 to 3 wt %), based on dry weight of the automatic dishwashing composition, of the silicate(s).

Preferably, the automatic dishwashing composition of the present invention, comprises: 0.2 to 15 wt % (preferably, 0.5 to 10 wt %; most preferably, 1.5 to 8.5 wt %), based on dry weight of the automatic dishwashing composition, of a nonionic surfactant. More preferably, the automatic dishwashing composition of the present invention, comprises: 0.2 to 15 wt % (preferably, 0.5 to 10 wt %; most preferably, 1.5 to 8.5 wt %), based on dry weight of the automatic dishwashing composition, of a nonionic surfactant; wherein the non-ionic surfactant is selected from the group consisting of polyoxyalkylene surfactants, polyalkylene glycol esters, polyoxyethylene derivatives of fatty acid esters of polyhydric alcohols, fatty acid esters of polyalkoxylated polyhydric alcohols, polyalkoxylated natural fats and oils, polyalkylene oxide block copolymers, alkyl polyglucosides, sucrose esters and mixtures thereof. Still more preferably, the automatic dishwashing composition of the present invention, comprises: 0.2 to 15 wt % (preferably, 0.5 to 10 wt %; most preferably, 1.5 to 8.5 wt %), based on dry weight of the automatic dishwashing composition, of a nonionic surfactant; wherein the non-ionic surfactant includes a fatty alcohol alkoxylate. Most preferably, the automatic dishwashing composition of the present invention, comprises: 0.2 to 15 wt % (preferably, 0.5 to 10 wt %; most preferably, 1.5 to 8.5 wt %), based on dry weight of the automatic dishwashing composition, of a nonionic surfactant; wherein the non-ionic surfactant is a fatty alcohol alkoxylate according to formula III

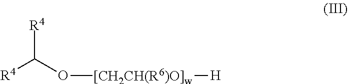

wherein w is an average of 5 to 100 (preferably, 6 to 75; more preferably, 7 to 60; most preferably, 8 to 50); wherein R⁴ is selected from the group consisting of a hydrogen and a linear or branched C₁₋₂₀ alkyl group (preferably, a hydrogen, and a linear or branched C₁₋₂₀ alkyl group; more preferably, a hydrogen and a linear C₁₋₂₀ alkyl group); wherein R⁵ is selected from the group consisting of a linear or branched C₁₋₂₀ alkyl group and a linear or branched C₁₋₄ hydroxyalkyl group (preferably, a linear or branched C₁₋₂₀ alkyl group; more preferably, a linear C₁₋₂₀ alkyl group); wherein each R⁶ is independently selected from the group consisting of a hydrogen, a methyl group, an ethyl group, a n-propyl group, an iso-propyl group, a n-butyl group, a 2-butyl group and a 2-methyl-2-butyl group (preferably, a hydrogen, a methyl group and an ethyl group); and with the proviso that sum of the total number of carbon atoms in R⁴ and R⁵ is 5 to 21 (preferably, 6 to 20 carbon atoms; more preferably, 7 to 20 carbon atoms).

Preferably, the automatic dishwashing composition of the present invention, comprises: 0.2 to 15 wt % (preferably, 0.5 to 10 wt %; most preferably, 1.0 to 5 wt %), based on dry weight of the automatic dishwashing composition, of a poly(glutamic acid). More preferably, the automatic dishwashing composition of the present invention, comprises: 0.2 to 15 wt % (preferably, 0.5 to 10 wt %; most preferably, 1.0 to 5 wt %), based on dry weight of the automatic dishwashing composition, of a poly(glutamic acid); wherein the poly(glutamic acid) has a weight average molecular weight of 1,000 to 200,000 Daltons (preferably, 2,000 to 150,000 Daltons; more preferably, 2,500 to 100,000 Daltons; still more preferably, 5,000 to 75,000 Daltons; most preferably; 7,500 to 60,000 Daltons). Still more preferably, the automatic dishwashing composition of the present invention, comprises: 0.2 to 15 wt % (preferably, 0.5 to 10 wt %; most preferably, 1.0 to 5 wt %), based on dry weight of the automatic dishwashing composition, of a poly(glutamic acid); wherein the poly(glutamic acid) has a weight average molecular weight of 1,000 to 200,000 Daltons (preferably, 2,000 to 150,000 Daltons; more preferably, 2,500 to 100,000 Daltons; still more preferably, 5,000 to 75,000 Daltons; most preferably; 7,500 to 60,000 Daltons); and wherein the poly(glutamic acid) is derived from L-glutamic acid, D-glutamic acid or a mixture thereof (e.g., a racemate of the L and D isomers). Most preferably, the automatic dishwashing composition of the present invention, comprises: 0.2 to 15 wt % (preferably, 0.5 to 10 wt %; most preferably, 1.0 to 5 wt %), based on dry weight of the automatic dishwashing composition, of a poly(glutamic acid); wherein the poly(glutamic acid) has a weight average molecular weight of 1,000 to 200,000 Daltons (preferably, 2,000 to 150,000 Daltons; more preferably, 2,500 to 100,000 Daltons; still more preferably, 5,000 to 75,000 Daltons; most preferably; 7,500 to 60,000 Daltons); and wherein the poly(glutamic acid) is derived from L-glutamic acid or a racemate of the L and D isomers.

Preferably, the poly(glutamic acid) used in the automatic dishwashing composition of the present invention comprise less than 1 mol % (preferably, <0.1 mol %; more preferably, <0.001 mol %; most preferably <detectable limit) of monomer residues other than from glutamic acid (e.g., aspartic acid, ethylene glycol, ethylene oxide, vinyl alcohol).

Preferably, the poly(glutamic acid) used in the automatic dishwashing composition of the present invention has an isoelectric point of <7. More preferably, the poly(glutamic acid) used in the automatic dishwashing composition of the present invention has an isoelectric point of <6. Yet more preferably, the poly(glutamic acid) used in the automatic dishwashing composition of the present invention has an isoelectric point of <5. Still more preferably, the poly(glutamic acid) used in the automatic dishwashing composition of the present invention has an isoelectric point of <4. Most preferably, the poly(glutamic acid) used in the automatic dishwashing composition of the present invention has an isoelectric point of <3.

Preferably, the automatic dishwashing composition of the present invention, comprises: 0.5 to 15 wt % (preferably, 0.5 to 10 wt %; more preferably, 1 to 8 wt %; most preferably, 2 to 6.5 wt %), based on dry weight of the automatic dishwashing composition, of a dispersant polymer. More preferably, the automatic dishwashing composition of the present invention, comprises: 0.5 to 15 wt % (preferably, 0.5 to 10 wt %; more preferably, 1 to 8 wt %; most preferably, 2 to 6.5 wt %), based on dry weight of the automatic dishwashing composition, of a dispersant polymer; wherein the dispersant polymer is selected from the group consisting of (a) a non-sulfonated hydrophobic modified polymer, comprising (i) 60 to 98 wt %, based on weight of the non-sulfonated hydrophobic modified polymer, of structural units of formula I

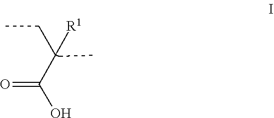

wherein each R¹ is independently selected from a hydrogen and a —CH₃ group; and (ii) 2 to 40 wt %, based on weight of the non-sulfonated hydrophobic modified polymer, of structural units of formula II

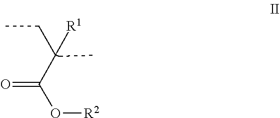

wherein each R² is independently selected from a —C₁₋₄ alkyl group and wherein each R³ is independently selected from a hydrogen and a methyl group; (b) a sulfonated polymer; (c) an acrylic acid homopolymer; and (d) mixtures thereof. Still more preferably, the automatic dishwashing composition of the present invention, comprises: 0.5 to 15 wt % (preferably, 0.5 to 10 wt %; more preferably, 1 to 8 wt %; most preferably, 2 to 6.5 wt %), based on dry weight of the automatic dishwashing composition, of a dispersant polymer; wherein the dispersant polymer is selected from the group consisting of a non-sulfonated hydrophobic modified polymer of (a), a sulfonated polymer of (b); and a blend of a non-sulfonated hydrophobic modified polymer of (a) and a sulfonated polymer of (b). Most preferably, the automatic dishwashing composition of the present invention, comprises: 0.5 to 15 wt % (preferably, 0.5 to 10 wt %; more preferably, 1 to 8 wt %; most preferably, 2 to 6.5 wt %), based on dry weight of the automatic dishwashing composition, of a dispersant polymer; wherein the dispersant polymer is selected from the group consisting of a non-sulfonated hydrophobic modified polymer of (a) and a blend of a non-sulfonated hydrophobic modified polymer of (a) and a sulfonated polymer of (b).

The non-sulfonated hydrophobic modified polymer of (a) used in the automatic dishwashing composition of the present invention comprises 60 to 98 wt % (preferably, 65 to <90 wt %; more preferably, 67 to 85 wt %; most preferably, 70 to 81 wt %), based on weight of the non-sulfonated hydrophobic modified polymer of (a), of structural units of formula I

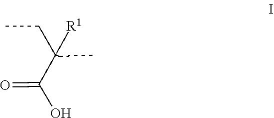

wherein each R¹ is independently selected from a hydrogen and a —CH₃ group. More preferably, the non-sulfonated hydrophobic modified polymer of (a) used in the automatic dishwashing composition of the present invention comprises 60 to 98 wt % (preferably, 65 to <90 wt %; more preferably, 67 to 85 wt %; most preferably, 70 to 81 wt %), based on weight of the non-sulfonated hydrophobic modified polymer of (a), of structural units of formula I; wherein R¹ is a hydrogen in 75 to 100 mol % (preferably, 90 to 100 mol %; more preferably, 98 to 100 mol %; still more preferably, ≥99 mol %; most preferably, 100 mol %) of the structural units of formula I in the non-sulfonated hydrophobic modified polymer of (a).

Preferably, the non-sulfonated hydrophobic modified polymer of (a) used in the automatic dishwashing composition of the present invention comprises 2 to 40 wt % (preferably, >10 to 35 wt %; more preferably, 15 to 33 wt %; most preferably, 19 to 30 wt %), based on weight of the non-sulfonated hydrophobic modified polymer of (a), of structural units of formula II

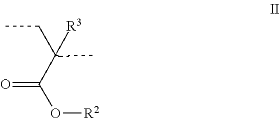

wherein each R² is independently selected from a —C₁₋₄ alkyl group (preferably, a —C₂₋₃ alkyl group; more preferably, an ethyl group) and wherein each R³ is independently selected from a hydrogen and a methyl group. More preferably, the non-sulfonated hydrophobic modified polymer of (a) used in the automatic dishwashing composition of the present invention comprises 2 to 40 wt % (preferably, >10 to 35 wt %; more preferably, 15 to 33 wt %; most preferably, 19 to 30 wt %), based on weight of the non-sulfonated hydrophobic modified polymer of (a), of structural units of formula II

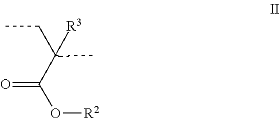

wherein each R² is independently selected from a —C₂₋₃ alkyl group (preferably, an ethyl group) and wherein each R³ is independently selected from a hydrogen and a methyl group. Most preferably, the non-sulfonated hydrophobic modified polymer of (a) used in the automatic dishwashing composition of the present invention comprises 2 to 40 wt % (preferably, >10 to 35 wt %; more preferably, 15 to 33 wt %; most preferably, 19 to 30 wt %), based on weight of the non-sulfonated hydrophobic modified polymer of (a), of structural units of formula II, wherein R² is an ethyl group in 75 to 100 mol % (preferably, 90 to 100 mol %; more preferably, 98 to 100 mol %; most preferably, 100 mol %) of the structural units of formula II in the non-sulfonated hydrophobic modified polymer of (a); and wherein R³ is a hydrogen in 75 to 100 mol % (preferably, 90 to 100 mol %; more preferably, 98 to 100 mol %; most preferably, 100 mol %) of the structural units of formula II in the non-sulfonated hydrophobic modified polymer.

Preferably, the non-sulfonated hydrophobic modified polymer of (a) used in the automatic dishwashing composition of the present invention has a weight average molecular weight of 1,200 to 25,000 Daltons. More preferably, the non-sulfonated hydrophobic modified polymer of (a) used in the automatic dishwashing composition of the present invention has a weight average molecular weight of 1,500 to 20,000 Daltons. Still more preferably, the non-sulfonated hydrophobic polymer of (a) used in the automatic dishwashing composition of the present invention has a weight average molecular weight of 1,750 to 17,500 Daltons. Most preferably, the non-sulfonated hydrophobic modified polymer of (a) used in the automatic dishwashing composition of the present invention has a weight average molecular weight of 1,900 to 14,250 Daltons.

Preferably, the non-sulfonated hydrophobic modified polymer of (a) used in the automatic dishwashing composition of the present invention comprises ≤0.3 wt % (preferably, ≤0.1 wt %; more preferably, ≤0.05 wt %; still more preferably, ≤0.03 wt %; most preferably, ≤0.01 wt %), based on weight of the non-sulfonated hydrophobic modified polymer of (a), of structural units of multi-ethylenically unsaturated crosslinking monomer.

Preferably, the non-sulfonated hydrophobic modified polymer of (a) used in the automatic dishwashing composition of the present invention comprises ≤1 wt % (preferably, ≤0.5 wt %; more preferably, ≤0.001 wt %; still more preferably, ≤0.0001 wt %; most preferably, <the detectable limit), based on weight of the non-sulfonated hydrophobic modified polymer of (a), of structural units of sulfonated monomer. More preferably, the non-sulfonated hydrophobic modified polymer of (a) used in the automatic dishwashing composition of the present invention comprises ≤1 wt % (preferably, ≤0.5 wt %; more preferably, ≤0.001 wt %; still more preferably, ≤0.0001 wt %; most preferably, <the detectable limit), based on weight of the non-sulfonated hydrophobic modified polymer of (a), of structural units of sulfonated monomer selected from the group consisting of 2-acrylamido-2-methylpropane sulfonic acid (AMPS), 2-methacrylamido-2-methylpropane sulfonic acid, 4-styrenesulfonic acid, vinylsulfonic acid, 3-allyloxy sulfonic acid, 2-hydroxy-1-propane sulfonic acid (HAPS), 2-sulfoethyl(meth)acrylic acid, 2-sulfopropyl(meth)acrylic acid, 3-sulfopropyl(meth)acrylic acid, 4-sulfobutyl(meth)acrylic acid and salts thereof. Most preferably, the non-sulfonated hydrophobic modified polymer of (a) used in the automatic dishwashing composition of the present invention comprises ≤1 wt % (preferably, ≤0.5 wt %; more preferably, ≤0.001 wt %; still more preferably, ≤0.0001 wt %; most preferably, <the detectable limit), based on weight of the non-sulfonated hydrophobic modified polymer of (a), of structural units of 2-acrylamido-2-methylpropane sulfonic acid (AMPS) monomer.

Methods of making the non-sulfonated hydrophobic modified polymer of (a) used in the automatic dishwashing composition of the present invention are well known to persons skilled in the art of copolymerization.

Preferably, the sulfonated polymer of (b) used in the automatic dishwashing composition of the present invention is a copolymer of acrylic acid and a sulfonated monomer. More preferably, the sulfonated polymer of (b) used in the automatic dishwashing composition of the present invention is a copolymer of acrylic acid and a sulfonated monomer; wherein the sulfonated monomer is selected from the group consisting of 2-acrylamido-2-methylpropane sulfonic acid (AMPS), 2-methacrylamido-2-methylpropane sulfonic acid, 4-styrenesulfonic acid, vinylsulfonic acid, 3-allyloxy sulfonic acid, 2-hydroxy-1-propane sulfonic acid (HAPS), 2-sulfoethyl(meth)acrylic acid, 2-sulfopropyl(meth)acrylic acid, 3-sulfopropyl(meth)acrylic acid, 4-sulfobutyl(meth)acrylic acid and salts thereof. Most preferably, the sulfonated polymer of (b) used in the automatic dishwashing composition of the present invention is a copolymer of acrylic acid and a sulfonated monomer; wherein the sulfonated monomer is selected from the group consisting of 2-acrylamido-2-methylpropane sulfonic acid (AMPS) and salts thereof.

Preferably, the sulfonated polymer of (b) used in the automatic dishwashing composition of the present invention, comprises: 50 to 95 wt % (preferably, 60 to 94 wt %; more preferably, 65 to 93 wt %; most preferably, 68 to 90 wt %), based on weight of the sulfonated polymer, of structural units of acrylic acid; and 5 to 50 wt % (preferably, 6 to 40 wt %; more preferably, 7 to 35 wt %; most preferably, 10 to 32 wt %), based on weight of the sulfonated polymer, of structural units of sulfonated monomer. More preferably, the sulfonated polymer of (b) used in the automatic dishwashing composition of the present invention, comprises: 50 to 95 wt % (preferably, 60 to 94 wt %; more preferably, 65 to 93 wt %; most preferably, 68 to 90 wt %), based on weight of the sulfonated polymer, of structural units of acrylic acid; and 5 to 50 wt % (preferably, 6 to 40 wt %; more preferably, 7 to 35 wt %; most preferably, 10 to 32 wt %), based on weight of the sulfonated polymer, of structural units of sulfonated monomer; wherein the sulfonated monomer is wherein the sulfonated monomer is selected from the group consisting of 2-acrylamido-2-methylpropane sulfonic acid (AMPS), 2-methacrylamido-2-methylpropane sulfonic acid, 4-styrenesulfonic acid, vinylsulfonic acid, 3-allyloxy sulfonic acid, 2-hydroxy-1-propane sulfonic acid (HAPS), 2-sulfoethyl(meth)acrylic acid, 2-sulfopropyl(meth)acrylic acid, 3-sulfopropyl(meth)acrylic acid, 4-sulfobutyl(meth)acrylic acid and salts thereof. Most preferably, the sulfonated polymer of (b) used in the automatic dishwashing composition of the present invention, comprises: 50 to 95 wt % (preferably, 60 to 94 wt %; more preferably, 65 to 93 wt %; most preferably, 68 to 90 wt %), based on weight of the sulfonated polymer, of structural units of acrylic acid; and 5 to 50 wt % (preferably, 6 to 40 wt %; more preferably, 7 to 35 wt %; most preferably, 10 to 32 wt %), based on weight of the sulfonated polymer, of structural units of sulfonated monomer; wherein the sulfonated monomer is selected from the group consisting of 2-acrylamido-2-methylpropane sulfonic acid (AMPS) and salts thereof.

Preferably, the sulfonated polymer of (b) used in the automatic dishwashing composition of the present invention has a weight average molecular weight, Mw, of 1,000 to 25,000 Daltons (preferably, 5,000 to 20,000 Daltons; more preferably, 7,500 to 17,500 Daltons; most preferably, 10,000 to 15,000 Daltons).

Preferably, the acrylic acid homopolymer of (c) used in the automatic dishwashing composition of the present invention has a weight average molecular weight, MW, of 1,000 to 40,000 Daltons (preferably, 1,000 to 20,000 Daltons; more preferably, 1,000 to 10,000 Daltons; most preferably, 2,000 to 4,000 Daltons).

The automatic dishwashing composition of the present invention, optionally further comprises: an additive. Preferably, the automatic dishwashing composition of the present invention, further comprises: an additive selected from the group consisting of a phosphonate (e.g., hydroxy ethylidene diphosphonic acid (HEDP); an alkaline source; a bleaching agent (e.g., sodium percarbonate, sodium perborate); a bleach activator (e.g., tetraacetylethylenediamine (TAED)); a bleach catalyst (e.g., manganese(II) acetate, cobalt(II) chloride, bis(TACN)magnesium trioxide diacetate); an enzyme (e.g., protease, amylase, lipase, or cellulase); a foam suppressant; a coloring agent; a fragrance; a silicate; an additional builder; an antibacterial agent; a filler; a deposit control polymer and mixtures thereof. More preferably, the automatic dishwashing composition of the present invention, further comprises an additive, wherein the additive is selected from the group consisting of a bleaching agent, a bleach activator, an enzyme, a filler and mixtures thereof. Still more preferably, the automatic dishwashing composition of the present invention, further comprises an additive, wherein the additive includes a bleaching agent (e.g., sodium percarbonate, sodium perborate); a bleach activator (e.g., tetraacetylethylenediamine (TAED)) and an enzyme (e.g., protease, amylase, lipase, or cellulase). Most preferably, the automatic dishwashing composition of the present invention, further comprises an additive, wherein the additive includes a bleaching agent, wherein the bleaching agent includes sodium percarbonate; a bleach activator, wherein the bleach activator includes tetraacetylethylenediamine (TAED); and an enzyme, wherein the enzyme includes a protease and an amylase.

Preferably, the automatic dishwashing composition of the present invention optionally further comprises 0 to 15 wt % (preferably, 0.1 to 15 wt %; more preferably, 0.5 to 10 wt %; still more preferably, 0.75 to 7.5 wt %; most preferably, 1 to 5 wt %), based on dry weight of the automatic dishwashing composition, of a phosphonate. More preferably, the automatic dishwashing composition of the present invention comprises 0 to 15 wt % (preferably, 0.1 to 15 wt %; more preferably, 0.5 to 10 wt %; still more preferably, 0.75 to 7.5 wt %; most preferably, 1 to 5 wt %), based on dry weight of the automatic dishwashing composition, of a phosphonate; wherein the phosphonate has a weight average molecular weight of ≤1,000 Daltons. Still more preferably, the automatic dishwashing composition of the present invention comprises 0 to 15 wt % (preferably, 0.1 to 15 wt %; more preferably, 0.5 to 10 wt %; still more preferably, 0.75 to 7.5 wt %; most preferably, 1 to 5 wt %), based on dry weight of the automatic dishwashing composition, of a phosphonate; wherein the phosphonate comprises at least one of 1-hydroxyethylidene-1,1-diphosphonic acid (HEDP) and a salt of 1-hydroxyethylidene-1,1-diphosphonic acid. Most preferably, the automatic dishwashing composition of the present invention comprises 0 to 15 wt % (preferably, 0.1 to 15 wt %; more preferably, 0.5 to 10 wt %; still more preferably, 0.75 to 7.5 wt %; most preferably, 1 to 5 wt %), based on dry weight of the automatic dishwashing composition, of a phosphonate; wherein the phosphonate is selected from the group consisting of 1-hydroxyethylidene-1,1-diphosphonic acid (HEDP) and salts thereof.

Fillers included in automatic dishwashing composition tablets or powders are inert, water-soluble substances, typically sodium or potassium salts (e.g., sodium sulfate, potassium sulfate, sodium chloride, potassium chloride). In tablets and powders, fillers are typically present in amounts ranging from 0 wt % to 75 wt %. Fillers included in gel formulations typically include those mentioned for use in tablets and powders and also water. Fragrances, dyes, foam suppressants, enzymes and antibacterial agents usually total no more than 10 wt %, alternatively no more than 5 wt %, of the automatic dishwashing composition.

The automatic dishwashing composition of the present invention, optionally further comprises: an alkaline source. Suitable alkaline sources include, without limitation, alkali metal carbonates and alkali metal hydroxides, such as sodium or potassium carbonate, bicarbonate, sesquicarbonate, sodium, lithium, or potassium hydroxide, or mixtures of the foregoing. Sodium hydroxide is preferred. The amount of alkaline source in the automatic dishwashing composition of the present invention (if any) is at least 1 wt % (preferably, at least 20 wt %) and up to 80 wt % (preferably, up to 60 wt %), based on dry weight of the automatic dishwashing composition.

The automatic dishwashing composition of the present invention, optionally further comprises: a bleaching agent (e.g., sodium percarbonate). The amount of the bleaching agent in the automatic dishwashing composition of the present invention (if any) is preferably at a concentration of 1 to 25 wt % (more preferably, 5 to 20 wt %), based on dry weight of the automatic dishwashing composition.

The automatic dishwashing composition of the present invention, optionally further comprises: a bleach activator (e.g., tetraacetylethylenediamine (TAED)). The amount of the bleach activator in the automatic dishwashing composition of the present invention (if any) is preferably at a concentration of 1 to 10 wt % (more preferably, 2.5 to 7.5 wt %), based on dry weight of the automatic dishwashing composition.

Preferably, the automatic dishwashing composition of the present invention comprises ≤1 wt % (preferably, ≤0.5 wt %; more preferably, ≤0.2 wt %; still more preferably, ≤0.1 wt %; yet still more preferably, ≤0.01 wt %; most preferably, <the detectable limit), based on dry weight of the automatic dishwashing composition, of phosphate. Preferably, the automatic dishwashing composition of the present invention is phosphate free.

Preferably, the automatic dishwashing composition of the present invention comprises ≤1 wt % (preferably, ≤0.5 wt %; more preferably, ≤0.2 wt %; still more preferably, ≤0.1 wt %; yet still more preferably, ≤0.01 wt %; most preferably, <the detectable limit), based on dry weight of the automatic dishwashing composition, of builders selected from the group consisting of nitrilotriacetic acid; ethylenediaminetetraacetic acid; diethylenetriaminepentaacetic acid; glycine-N,N-diacetic acid; methyl glycine-N,N-diacetic acid; 2-hydroxyethyliminodiacetic acid; glutamic acid-N,N-diacetic acid; 3-hydroxy-2,2′-iminodissuccinate; S,S-ethylenediaminedisuccinate aspartic acid-diacetic acid; N,N′-ethylene diamine disuccinic acid; iminodisuccinic acid; aspartic acid; aspartic acid-N,N-diacetic acid; beta-alaninediacetic acid; polyaspartic acid; salts thereof and mixtures thereof. Most preferably, the automatic dishwashing composition of the present invention contains 0 wt % of builders selected from the group consisting of nitrilotriacetic acid; ethylenediaminetetraacetic acid; diethylenetriaminepentaacetic acid; glycine-N,N-diacetic acid; methyl glycine-N,N-diacetic acid; 2-hydroxyethyliminodiacetic acid; glutamic acid-N,N-diacetic acid; 3-hydroxy-2,2′-iminodissuccinate; S,S-ethylenediaminedisuccinate aspartic acid-diacetic acid; N,N′-ethylene diamine disuccinic acid; iminodisuccinic acid; aspartic acid; aspartic acid-N,N-diacetic acid; beta-alaninediacetic acid; polyaspartic acid; salts thereof and mixtures thereof.

Preferably, the automatic dishwashing composition of the present invention comprises <0.1 wt % (preferably, <0.01 wt %; more preferably, <0.001 wt %; still more preferably, <0.0001 wt %; yet still more preferably, <0.00001 wt %; most preferably, <the detectable limit), based on dry weight of the automatic dishwashing composition, of esterified benzene sulfonate of formula IV

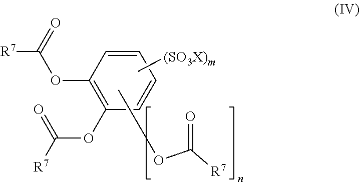

wherein each R⁷ is independently selected from the group consisting of hydrogen and a C₁₋₁₁ alkyl; wherein m is a 1 to 2; wherein n is 0 to 3; and wherein X is a suitable water soluble cation (e.g., a sodium cation).

Preferably, the automatic dishwashing composition of the present invention comprises <0.0001 wt % (preferably, <0.00001 wt %; more preferably, <0.000001 wt %; still more preferably, <0.0000001 wt %; most preferably, <the detectable limit), based on dry weight of the automatic dishwashing composition, of a metal complex of formula V

(LᵥMe_{y}Aₓ)^{z}Y_{q} (V)

wherein Me is selected from the group consisting of manganese, titanium, iron, cobalt, nickel and copper; wherein A is selected from the group consisting of a coordinating radical and a bridging radical; wherein v and y are each independently an integer having a value of 1 to 8; wherein x is an integer having a value of 0 to 32; wherein z is the charge of the metal complex;
wherein Y is a counter-ion; wherein q=z/(charge of counter-ion Y); and wherein L is a ligand of formula VI

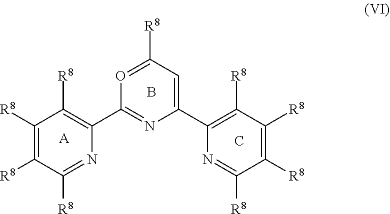

wherein Q is selected from the group consisting of N and CR⁹; wherein each R⁸ is independently selected from the group consisting of hydrogen, unsubstituted C₁₋₁₈ alkyl, substituted C₁₋₁₈ alkyl, unsubstituted aryl, substituted aryl, cyano, halogen, nitro, —COOR¹⁰, and —SO₃R¹⁰; wherein each R⁹ is independently selected from the group consisting of hydrogen, a cation, substituted C₁₋₁₈ alkyl, unsubstituted C₁₋₁₈ alkyl, substituted aryl, unsubstituted aryl, —SR¹⁰, —SO₂R¹⁰ and —OR¹⁰; —NR¹¹R¹², —(C₁₋₆ alkylene)-NR¹¹R¹², —N⁺R¹¹R¹²R¹³, —(C₁₋₆ alkylene)-N⁺R¹¹R¹²R¹³, —N(R¹⁰)—(C₁₋₆ alkylene)-NR¹¹R¹², —N[(C₁₋₆ alkylene)-NR¹¹R¹²]₂, —N(R¹⁰)—(C₁₋₆ alkylene)-N⁺R¹¹R¹²R¹³, —N[(C₁₋₆ alkylene)-N⁺R¹¹R¹²R¹³]₂, —N(R¹⁰)—NR¹¹R¹² and —N(R¹⁰)—N⁺R¹¹R¹²R¹³; wherein each R¹⁰ is independently selected from the group consisting of hydrogen, substituted C₁₋₁₈ alkyl, unsubstituted C₁₋₁₈ alkyl, substituted aryl and unsubstituted aryl; wherein each R¹¹ and R¹² is independently selected from the group consisting of hydrogen, unsubstituted C₁₋₁₈ alkyl, substituted C₁₋₁₈ alkyl, unsubstituted aryl, substituted aryl or, together with the nitrogen atom linking them, form an unsubstituted or substituted 5-, 6- or 7-membered ring which may contain further hetero atoms; and wherein R¹³ is selected from the group consisting of hydrogen, unsubstituted C₁₋₁₈ alkyl, substituted C₁₋₁₈ alkyl, unsubstituted aryl and substituted aryl.

Preferably, the automatic dishwashing composition of the present invention has a pH (at 1 wt % in water) of at least 9 (preferably, ≥10; more preferably, ≥11.5). Preferably, the automatic dishwashing composition of the present invention has a pH (at 1 wt % in water) of no greater than 13.

Preferably, the automatic dishwashing composition of the present invention can be formulated in any typical form, e.g., as a tablet, powder, block, monodose, sachet, paste, liquid or gel. The automatic dishwashing compositions of the present invention are useful for cleaning ware, such as eating and cooking utensils, dishes, in an automatic dishwashing machine.

Preferably, the automatic dishwashing composition of the present invention are suitable for use under typical operating conditions. For example, when used in an automatic dishwashing machine, typical water temperatures during the washing process preferably are from 20° C. to 85° C., preferably 30° C. to 70° C. Typical concentrations for the automatic dishwashing composition as a percentage of total liquid in the dishwasher preferably are from 0.1 to 1 wt %, preferably from 0.2 to 0.7 wt %. With selection of an appropriate product form and addition time, the automatic dishwashing compositions of the present invention may be present in the prewash, main wash, penultimate rinse, final rinse, or any combination of these cycles.

Preferably, the method of cleaning an article in an automatic dishwashing machine of the present invention, comprises: providing at least one soiled article (e.g., cookware, bakeware, tableware, dishware, flatware and/or glassware); providing an automatic dishwashing composition of the present invention; and applying the automatic dishwashing composition to the at least one soiled article (preferably, in an automatic dishwasher) to provide a clean article.

Some embodiments of the present invention will now be described in detail in the following Examples.

### Comparative Examples C1-C10 and Examples 1-4: Automatic Dishwashing Compositions

Dishwashing compositions were prepared in each of Comparative Examples C1-C10 and Examples 1-4 having the component formulations identified in TABLE 1. The amylase used in Comparative Examples C1-C7 and Examples 1-2 was Stainzyme® 12T amylase available from Novozymers. The amylase used in Comparative Examples C8-C10 and Examples 3-4 was Excellenz® S1000 amylase available from DuPont. The protease used in all of the compositions was Savinase® 12T protease available from Novozymes.

TABLE 1

| | Example (Concentration in wt %) | | | | | | | | | | | | | |
|---|---|---|---|---|---|---|---|---|---|---|---|---|---|---|
| Ingredient | C1 | C2 | C3 | C4 | C5 | C6 | C7 | C8 | C9 | C10 | 1 | 2 | 3 | 4 |
| Sodium | 30 | 30 | 30 | 30 | 30 | 30 | 30 | 30 | 30 | 28 | 30 | 30 | 30 | 28 |
| carbonate | | | | | | | | | | | | | | |
| Sodium citrate | 20 | 20 | 20 | 20 | 20 | 20 | 20 | 20 | 20 | 20 | 20 | 20 | 20 | 20 |
| Sodium | 15 | 15 | 15 | 15 | 15 | 15 | 15 | 15 | 15 | 15 | 15 | 15 | 15 | 15 |
| percarbonate | | | | | | | | | | | | | | |
| TAED | 3.2 | 3.2 | 3.2 | 3.2 | 3.2 | 3.2 | 3.2 | 3.2 | 3.2 | 3.3 | 3.2 | 3.2 | 3.2 | 3.3 |
| Branched | 5.6 | 5.6 | 5.6 | 5.6 | 5.6 | 5.6 | 5.6 | 5.6 | 5.6 | 5.4 | 5.6 | 5.6 | 5.6 | 5.4 |
| alcohol | | | | | | | | | | | | | | |
| alkoxylate¹ | | | | | | | | | | | | | | |
| Alcohol | — | — | — | — | — | — | — | — | — | 2.7 | — | — | — | 2.7 |
| alkoxylate² | | | | | | | | | | | | | | |
| HEDP³ | 4.0 | 4.0 | 4.0 | 4.0 | 4.0 | 4.0 | 4.0 | 4.0 | 4.0 | 3.8 | 4.0 | 4.0 | 4.0 | 3.8 |
| Amylase | 2.8 | 2.8 | 2.8 | 2.8 | 2.8 | 2.8 | 2.8 | 2.8 | 2.8 | 2.7 | 2.8 | 2.8 | 2.8 | 2.7 |
| Protease | 2.8 | 2.8 | 2.8 | 2.8 | 2.8 | 2.8 | 2.8 | 2.8 | 2.8 | 2.7 | 2.8 | 2.8 | 2.8 | 2.7 |
| Sodium | 2.0 | 2.0 | 2.0 | 2.0 | 2.0 | 2.0 | 2.0 | 2.0 | 2.0 | 2.2 | 2.0 | 2.0 | 2.0 | 2.2 |
| disilicate | | | | | | | | | | | | | | |
| Sodium sulfate | 9 | 9 | 9 | 14.6 | 9 | 9 | 9 | 9 | 9 | 8.6 | 9 | 9 | 9 | 8.6 |
| PGA-1⁴ | — | — | — | — | 5.6 | — | — | — | — | — | 2.8 | 2.8 | — | — |
| PGA-2⁵ | — | — | — | — | — | — | — | — | 2.8 | — | — | — | 2.8 | 2.8 |
| Dispersant-1⁶ | 5.6 | — | — | — | — | 2.8 | 2.8 | 2.8 | 2.8 | 2.8 | — | — | — | — |
| Dispersant-2⁷ | — | 5.6 | — | — | — | 2.8 | — | 2.8 | — | 2.8 | 2.8 | — | — | — |
| Dispersant-3⁸ | — | — | 5.6 | — | — | — | 2.8 | — | — | — | — | 2.8 | 2.8 | 2.8 |

¹ECOSURF ™ LFE-1410 nonionic surfactant available from The Dow Chemical Company
²ECOSURF ™ Bright 1 nonionic surfactant available from The Dow Chemical Company
³Cublen K8514G organophosphonate available from Zschimmer & Schwarz
⁴Poly(glutamic acid) having weight average molecular weight of 10,000 Daltons available from Spec-Chem Industry Inc.
⁵Poly(glutamic acid) having weight average molecular weight of 50,000 Daltons available from Spec-Chem Industry Inc.
⁶ACUSOL ™ 445NG dispersant polymer available from The Dow Chemical Company
⁷ACUSOL ™ 588G dispersant polymer available from The Dow Chemical Company
⁸ACUSOL ™ 527G dispersant polymer available from The Dow Chemical Company

### Procedure for Preparing Food Soil

The IKW food soil described in TABLE 2 was prepared by the following procedure.
a) Combine vegetable oil and whole egg and mix thoroughly with a hand blend until the mixture is homogeneous.
b) Add ketchup and mustard, still stirring vigorously.
c) Melt the fats, allow to cool to ˜40° C., then add to the mixture from b) and blend in well.
d) Stir cream and milk into c); and
e) Add the powdered solid constituents into d) and mix to a smooth paste.

TABLE 2

| Ingredient | wt % |
|---|---|
| Sunflower oil | 31.6 |
| Margarine (Plantafin) | 6.3 |
| Lard (Blanc de Boeuf) | 6.3 |
| Deep-frying fat (Solo) | 6.3 |
| Whole egg | 15.8 |
| 35% fat cream | 9.4 |
| Whole milk, pasteurized, 3.5% fat | 6.3 |
| Potato starch | 2.2 |
| Gravy (Fond de veau, Knorr) | 1.7 |
| Wheat flour | 0.6 |
| Quark powder | 0.6 |
| Benzoic acid >99.9% | 0.3 |
| Tomato ketchup | 6.3 |
| Mustard | 6.3 |

### Dishwashing Test Conditions

Machine: Miele SS-ADW, Model G1222SC Labor. Wash at 50° C.-8 min/rinse 65° C. Water: 380 ppm total hardness, Ca⁺²:Mg⁺²=3:1. Ratio of Deionized water with 250 ppm Na-bicarbonate (TH=37° FH, TAC=23° FH). Food soil: 50 g of the composition noted in TABLE 2 was introduced to the wash liquor frozen in a cup. Each dishwashing composition from Comparative Examples C1-C10 and Examples 1-4 were tested, as noted in TABLES 3-5, dosed at 18 g per wash.

### Filming and Spotting Evaluation

After each of 5 wash cycles under the above dishwashing test conditions, the glass tumblers, wine glasses, SAN glasses and stainless steel butter dishes were dried in open air. After drying, filming and spotting ratings were determined by trained evaluators by observations of glass tumblers, wine glasses, SAN glasses in a light box with controlled illumination from below; and by observations of the stainless steel butter dishes with controlled illumination from above. Glass tumblers, wine glasses, SAN glasses and stainless steel butter dishes were rated for filming and spotting according to ASTM method ranging from 1 (no film/spots) to 5 (heavily filmed/spotted). An average value of 1 to 5 for filming and spotting was determined as reported in TABLES 3-5. Also reported in TABLES 3-5 are the values for overall spot, overall film and overall shine (i.e., overall spot+overall film) for each dishwashing composition.

TABLE 3
TEST 1

| | Tumblers | | Wine | | SAN | | Butter | | Overall | | |
|---|---|---|---|---|---|---|---|---|---|---|---|
| Comp. | Film | Spot | Film | Spot | Film | Spot | Film | Spot | Film | Spot | Shine |
| C1 | 4 | 1 | 3 | 1 | 2 | 3 | 3 | 1.5 | 12 | 6.5 | 18.5 |
| C2 | 1 | 4 | 1.5 | 2 | 1.5 | 3 | 1.5 | 3 | 5.5 | 12 | 17.5 |
| C3 | 1.5 | 3 | 1.5 | 3 | 3 | 3.5 | 1.5 | 3 | 7.5 | 12.5 | 20.5 |
| C4 | 2.5 | 3.5 | 2 | 3 | 4 | 2 | 1.5 | 2 | 10 | 10.5 | 20.5 |
| C5 | 4 | 1 | 4 | 1 | 3 | 3 | 3 | 1.5 | 14 | 6.5 | 20.5 |

TABLE 4
TEST 2

| | Tumblers | | Wine | | SAN | | Butter | | Overall | | |
|---|---|---|---|---|---|---|---|---|---|---|---|
| Comp. | Film | Spot | Film | Spot | Film | Spot | Film | Spot | Film | Spot | Shine |
| C6 | 2 | 1.5 | 2.5 | 2.5 | 2 | 4 | 1.5 | 4 | 8 | 12 | 20 |
| C7 | 2.5 | 1.5 | 3 | 2 | 3.5 | 4 | 1.5 | 2 | 10.5 | 9.5 | 20 |
| 1 | 1.5 | 2.5 | 1.5 | 2.5 | 2 | 3 | 1.5 | 3 | 6.5 | 11 | 17.5 |
| 2 | 1.5 | 2.5 | 1.5 | 2.5 | 2.5 | 4 | 1.5 | 2.5 | 7 | 11.5 | 18.5 |

TABLE 5
TEST 3

| | Tumblers | | Wine | | SAN | | Butter | | Overall | | |
|---|---|---|---|---|---|---|---|---|---|---|---|
| Comp. | Film | Spot | Film | Spot | Film | Spot | Film | Spot | Film | Spot | Shine |
| C8 | 3 | 3.5 | 5 | 4 | 3.5 | 2.5 | 3.5 | 4 | 15 | 14 | 29 |
| C9 | 4.5 | 1.5 | 5 | 2 | 4.5 | 1.5 | 4 | 2.5 | 18 | 7.5 | 25.5 |
| C10 | 3.5 | 1.5 | 3 | 2 | 3 | 3 | 2.5 | 1.5 | 8 | 12 | 20 |
| 3 | 1.5 | 2.5 | 2 | 3.5 | 3.5 | 2 | 2 | 3.5 | 9 | 11.5 | 20.5 |
| 4 | 1.5 | 1.5 | 3 | 1.5 | 4.5 | 3.5 | 2.5 | 2 | 11.5 | 8.5 | 20 |

### Comparative Examples C11-C17 and Examples 5-8: Automatic Dishwashing Compositions

Dishwashing compositions were prepared in each of Comparative Examples C11-C17 and Examples 5-8 having the component formulations identified in TABLE 6. The amylase used is each of the compositions was Excellenz® S1000 amylase available from DuPont. The protease used in all of the compositions was Excellenz® P1000 protease available from DuPont.

TABLE 6

| | Example (Concentration in wt %) | | | | | | | | | | |
|---|---|---|---|---|---|---|---|---|---|---|---|
| Ingredient | C11 | C12 | C13 | C14 | C15 | C16 | C17 | 5 | 6 | 7 | 8 |
| TDA¹ | — | — | — | — | — | 23.5 | 23.5 | — | — | — | 23.1 |
| Sodium | 31 | 30.2 | 30.2 | 31.4 | 31.4 | 43.0 | 43.0 | 30.2 | 30.2 | 31 | 42.3 |
| carbonate | | | | | | | | | | | |
| Sodium | 31 | 30.2 | 30.2 | 31.4 | 31.4 | — | — | 30.2 | 30.2 | 31 | — |
| citrate | | | | | | | | | | | |
| Sodium | 15.7 | 15.0 | 15.0 | 16 | 16 | 13.0 | 13.0 | 15.0 | 15.0 | 15.4 | 12.8 |
| percarbonate | | | | | | | | | | | |
| TAED | 4.0 | 4.0 | 4.0 | 4.1 | 4.1 | 4.5 | 4.5 | 4.0 | 4.0 | 4.1 | 4.5 |
| Alcohol | — | — | — | — | — | 3.3 | 3.3 | — | — | — | 3.3 |
| alkoxylate-1² | | | | | | | | | | | |
| Alcohol | 6.3 | 6.0 | 6.0 | 6.4 | 6.4 | 2.0 | 2.0 | 6.0 | 6.0 | 6.4 | — |
| alkoxylate-2³ | | | | | | | | | | | |
| Alcohol | — | — | — | — | — | — | — | — | — | — | 1.9 |
| alkoxylate-3⁴ | | | | | | | | | | | |
| Amylase | 1.7 | 1.5 | 1.5 | 1.7 | 1.7 | 3.9 | 3.9 | 1.5 | 1.5 | 1.7 | 3.8 |
| Protease | 1.7 | 1.5 | 1.5 | 1.7 | 1.7 | 3.9 | 3.9 | 1.5 | 1.5 | 1.7 | 3.8 |
| Sodium | 1.1 | 1.1 | 1.1 | 1.2 | 1.2 | 1.3 | 1.3 | 1.1 | 1.1 | 1.2 | 1.3 |
| disilicate | | | | | | | | | | | |
| Benzotriazole | 0.6 | 0.5 | 0.5 | 0.6 | 0.6 | — | — | 0.5 | 0.5 | 0.6 | — |
| PGA-1⁵ | 2.9 | — | — | 1.4 | — | 1.6 | — | 3.0 | 3.0 | 1.4 | 1.6 |
| Dispersant-1⁶ | — | 3.0 | 3.0 | — | 1.4 | — | 1.6 | 3.0 | — | 1.4 | 1.6 |
| Dispersant-2⁷ | — | 3.0 | — | — | — | — | — | — | — | — | — |
| Dispersant-3⁸ | — | — | 3.0 | — | — | — | — | — | — | — | — |
| Dispersant 4⁹ | — | — | — | — | — | — | — | — | 3.0 | — | — |
| PEG¹⁰ | 4.0 | 4.0 | 4.0 | 4.1 | 4.1 | — | — | 4.0 | 4.0 | 4.1 | — |

¹TRILON ™ M pulver trisodium dicarboxymethyl alaninate from BASF
²TERGITOL ™ 15-S-7 nonionic surfactant from The Dow Chemical Company
³DOWFAX ™ 20B102 nonionic surfactant from The Dow Chemical Company
⁴ECOSURF ™ LFE-1410 nonionic surfactant from The Dow Chemical Company
⁵Poly(glutamic acid) having weight average molecular weight of 10,000 Daltons from Spec-Chem Industry Inc.
⁶ACUSOL ™ 445NG dispersant polymer from The Dow Chemical Company
⁷ACUSOL ™ 588G dispersant polymer from The Dow Chemical Company
⁸ACUSOL ™ 527G dispersant polymer from The Dow Chemical Company
⁹ACUSOL ™ 402N dispersant polymer from The Dow Chemical Company
¹⁰CARBOWAX ™ PEG8000 polyethylene glycol from The Dow Chemical Company

### Procedure for Preparing Food Soil

The STIWA food soil described in TABLE 7 was prepared by the following procedure.
f) Bringing the water to a boil.
g) Mixing in a paper cup the instant gravy, the benzoic acid and the starch; and then adding the mixture to the boiling water.
h) Adding the milk and margarine to the product of (b).
i) Letting the product of (c) cool down to approximately 40° C., and then adding mixture to a kitchen mixer (Polytron).
j) Combining in another paper cup, the egg yolk, the ketchup and the mustard and mixing with a spoon.
k) Adding the product of (e) to the mixture of (d) in the blender with continuous stirring.
l) Letting the product of (f) stir in the blender for 5 minutes.
m) The freezing the product food soil mixture from (g).
n) 50 g of the frozen slush is placed into the dishwasher at beginning of the main wash.

TABLE 7

| Ingredient | wt % |
|---|---|
| Water | 70.9 |
| Margarine | 10.1 |
| Gravy Powder | 2.5 |
| Potato Starch | 0.5 |
| Benzoic Acid | 0.1 |
| Egg Yolk | 5.8 |
| Mustard | 2.5 |
| Ketchup | 2.5 |
| Milk | 5.1 |

### Dishwashing Test Conditions

Machine: Miele SS-ADW, Model G1222SC Labor (GSL2). Wash at 65° C.-30 min/rinse 65° C. Water: 380 ppm total hardness, Ca²⁺:Mg²⁺=3:1. Ratio of deionized water with 250 ppm Na-bicarbonate (TH=37° FH, TAC=23° FH). Food soil: 50 g of the composition noted in TABLE 7 was introduced to the wash liquor frozen in a cup. Each dishwashing composition from Comparative Examples C11-C17 and Examples 5-8 were tested, dosed at the quantities noted in TABLE 8.

TABLE 8

| Composition | Dosage (g) |
|---|---|
| Comp. Ex. C11 | 17.5 |
| Comp. Ex. C12 | 18.0 |
| Comp. Ex. C13 | 18.0 |
| Comp. Ex. C14 | 17.25 |
| Comp. Ex. C15 | 17.25 |
| Comp. Ex. C16 | 15.35 |
| Comp. Ex. C17 | 15.35 |
| Example 5 | 18.0 |
| Example 6 | 18.0 |
| Example 7 | 17.5 |
| Example 8 | 15.6 |

### Filming and Spotting Evaluation

After each of 5 wash cycles under the above dishwashing test conditions, the glass tumblers, wine glasses, SAN glasses and stainless steel butter dishes were dried in open air. After drying, filming and spotting ratings were determined by trained evaluators by observations of glass tumblers, wine glasses, SAN glasses in a light box with controlled illumination from below; and by observations of the stainless steel butter dishes with controlled illumination from above. Glass tumblers, wine glasses, SAN glasses and stainless steel butter dishes were rated for filming and spotting according to ASTM method ranging from 1 (no film/spots) to 5 (heavily filmed/spotted). An average value of 1 to 5 for filming and spotting was determined as reported in TABLES 9-11. Also reported in TABLES 9-11 are the values for overall spot, overall film and overall shine (i.e., overall spot+overall film) for each dishwashing composition.

TABLE 9
TEST 4

| | Tumblers | | Wine | | SAN | | Butter | | Overall | | |
|---|---|---|---|---|---|---|---|---|---|---|---|
| Comp. | Film | Spot | Film | Spot | Film | Spot | Film | Spot | Film | Spot | Shine |
| C11 | 5 | 1.5 | 5 | 1.5 | 5 | 2 | 5 | 2 | 20 | 7 | 27 |
| C12 | 4 | 1.5 | 4.5 | 1.5 | 5 | 1.5 | 3.5 | 1.5 | 17 | 6 | 23 |
| C13 | 4.5 | 1.5 | 5 | 1.5 | 5 | 2 | 4.5 | 1.5 | 19 | 6.5 | 25.5 |
| 5 | 3 | 2 | 3.5 | 2 | 5 | 2 | 3.5 | 2 | 15 | 8 | 23 |
| 6 | 3 | 2 | 3.5 | 3 | 5 | 2 | 3 | 1.5 | 14.5 | 8.5 | 23 |

TABLE 10
TEST 5

| | Tumblers | | Wine | | SAN | | Butter | | Overall | | |
|---|---|---|---|---|---|---|---|---|---|---|---|
| Comp. | Film | Spot | Film | Spot | Film | Spot | Film | Spot | Film | Spot | Shine |
| C14 | 5 | 3.5 | 5 | 3.5 | 5 | 3.5 | 5 | 2 | 20 | 12.5 | 32.5 |
| C15 | 4 | 3 | 4 | 3.5 | 4.5 | 3.5 | 4.5 | 2.5 | 17 | 12.5 | 29.5 |
| 7 | 3.5 | 3.5 | 3.5 | 4 | 4.5 | 3.5 | 4 | 2 | 15.5 | 13 | 28.5 |

TABLE 11
TEST 6

| | Tumblers | | Wine | | SAN | | Butter | | Overall | | |
|---|---|---|---|---|---|---|---|---|---|---|---|
| Comp. | Film | Spot | Film | Spot | Film | Spot | Film | Spot | Film | Spot | Shine |
| C16 | 5 | 3.5 | 5 | 3.5 | 5 | 3.5 | 5 | 2 | 20 | 12.5 | 32.5 |
| C17 | 4 | 4.5 | 4.5 | 4 | 5 | 3.5 | 3 | 3 | 16.5 | 15 | 31.5 |
| 8 | 3 | 3.5 | 4 | 4 | 4.5 | 3.5 | 3.5 | 3.5 | 15 | 14.5 | 29.5 |

We claim:

1. An automatic dishwashing composition, comprising:
a builder;
a nonionic surfactant;
a poly(glutamic acid); and
dispersant polymer selected from the group consisting of:
(a) a non-sulfonated hydrophobic modified polymer, comprising
(i) 60 to 98 wt %, based on weight of the non-sulfonated hydrophobic modified polymer, of structural units of formula I 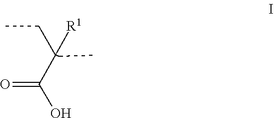
wherein each R¹ is independently selected from a hydrogen and a —CH₃ group; and
(ii) 2 to 40 wt %, based on weight of the non-sulfonated hydrophobic modified polymer, of structural units of formula II 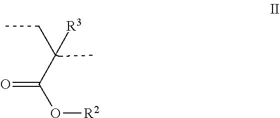
wherein each R² is independently selected from a —C₁₋₄ alkyl group and wherein each R³ is independently selected from a hydrogen and a methyl group;
(b) a sulfonated polymer;
(c) an acrylic acid homopolymer; and
(d) a mixtures thereof.

2. The automatic dishwashing composition of claim 1, wherein the builder is selected from the group consisting of carbonate, bicarbonate, citrate, silicate and mixtures thereof.

3. The automatic dishwashing composition of claim 2, wherein the dispersant polymer includes the sulfonated polymer of (b).

4. The automatic dishwashing composition of claim 2, wherein the dispersant polymer includes the non-sulfonated hydrophobic modified polymer of (a).

5. The automatic dishwashing composition of claim 4, wherein the dispersant polymer is the non-sulfonated hydrophobic modified polymer of (a).

6. The automatic dishwashing composition of claim 5, wherein the automatic dishwashing composition contains 0 wt %, based on dry weight of the automatic dishwashing composition, of builders selected from the group consisting of nitrilotriacetic acid; ethylenediaminetetraacetic acid; diethylenetriaminepentaacetic acid; glycine-N,N-diacetic acid; methyl glycine-N,N-diacetic acid; 2-hydroxyethyliminodiacetic acid; glutamic acid-N,N-diacetic acid; 3-hydroxy-2,2′-iminodissuccinate; S,S-ethylenediaminedisuccinate aspartic acid-diacetic acid; N,N′-ethylene diamine disuccinic acid; iminodisuccinic acid; aspartic acid; aspartic acid-N,N-diacetic acid; beta-alaninediacetic acid; polyaspartic acid; salts thereof and mixtures thereof.

7. The automatic dishwashing composition of claim 6, further comprising an additive.

8. The automatic dishwashing composition of claim 7, wherein the additive is selected from the group consisting of a bleaching agent, a bleach activator, an enzyme, a filler, and mixtures thereof.

9. The automatic dishwashing composition of claim 8, further comprising an additive, wherein the additive includes a mixture of a bleaching agent; a bleach activator and an enzyme.

10. A method of cleaning an article in an automatic dishwashing machine, comprising:
providing at least one article;
providing an automatic dishwashing composition according to claim 1; and,
applying the automatic dishwashing composition to the at least one article.
